(19) United States
(12) Patent Application Publication
(10) Pub. No.: US 2008/0273225 A1
(43) Pub. Date: Nov. 6, 2008

(54) IMAGE PROCESSING SYSTEM, IMAGE PROCESSING APPARATUS, CONTROL METHOD FOR IMAGE PROCESSING APPARATUS, AND CONTROL PROGRAM FOR IMAGE PROCESSING APPARATUS

(75) Inventor: Makoto Mihara, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/111,431

(22) Filed: Apr. 29, 2008

(30) Foreign Application Priority Data
May 1, 2007 (JP) 2007-120982

(51) Int. Cl. G06F 15/00

(52) U.S. Cl. 358/1.15

(57) ABSTRACT

An image processing system which can easily change settings on a linking image processing apparatus when a linked image processing apparatus is replaced to result in changes in setting information such as an IP address and functions of the image processing apparatus. The image processing system comprises an image processing apparatus, and another image processing apparatus which performs a processing through linkage with the image processing apparatus. The image processing apparatus receives configuration information including identification information which identifies an apparatus and function information which represents functions of the apparatus, compares the configuration information received by the receiving unit with configuration information about the image processing apparatus, and reports to the another image processing apparatus that there is a difference in the identification information or in the identification information, as a result of the comparison made by the comparison unit.

### BACKGROUND OF THE INVENTION

1. Field of the Invention

The present invention relates to an image processing system equipped with a plurality of image processing apparatuses connected with one another via a network as well as to the image processing apparatus of the image processing system, a control method for the image processing apparatus, and a control program for the image processing apparatus.

2. Description of the Related Art

Conventionally, in this type of image processing system, to mutually link a plurality of image processing apparatuses with one another via a network, an IP address of a linked image processing apparatus is registered in a linking image processing apparatus. However, if a desired linked image processing apparatus is replaced and the IP address and functions of the linked image processing apparatus are changed, it is necessary to change settings in all the image processing apparatuses in which the IP address of the not-yet-replaced image processing apparatus has been registered.

On the other hand, a technique has been proposed which automatically reports any change in the IP address of an image processing apparatus to the other image processing apparatus which uses the given image processing apparatus and changes IP address information about the given image processing apparatus registered in the other image processing apparatus (see, for example, Japanese Laid-Open Patent Publication (Kokai) No. 2002-123380).

However, the technique described above only allows for link processing in the case where the IP address of an image processing apparatus is changed. Consequently, the technique cannot deal with a situation in which an IP address no longer represents the most suitable link target because an image processing apparatus has been replaced with another image processing apparatus with different functions without a change in the IP address or a situation in which an image processing apparatus is replaced with another image processing apparatus with a different IP address and different functions. This imposes burdens on users because when an image processing apparatus is replaced, the users must find other image processing apparatuses linking to the replaced image processing apparatus and change settings to optimize the link to the replaced image processing apparatus for each of the other image processing apparatuses linking to the replaced image processing apparatus.

### SUMMARY OF THE INVENTION

The present invention provides an image processing system, an image processing apparatus, a control method for the image processing apparatus, and a control program for the image processing apparatus, which can easily change settings on a linking image processing apparatus when a linked image processing apparatus is replaced to result in changes in setting information such as an IP address and functions of the image processing apparatus.

In a first aspect of the present invention, there is provided with an image processing system comprising an image processing apparatus, and another image processing apparatus which performs a processing through linkage with the image processing apparatus, wherein the image processing apparatus comprises: a receiving unit configured to receive configuration information including identification information which identifies an apparatus and function information which represents functions of the apparatus; a comparison unit configured to compare the configuration information received by the receiving unit with configuration information about the image processing apparatus; and a reporting unit configured to, as a result of the comparison made by the comparison unit, report to the another image processing apparatus that there is a difference in the identification information if there is a difference in the identification information but there is no difference in the function information, report to the another image processing apparatus that there is a difference in the function information if there is no difference in the identification information but there is a difference in the function information, and report to the another image processing apparatus that there are differences both in the identification information and in the function information, respectively, if there are differences both in the identification information and in the function information, respectively, and wherein the another image processing apparatus comprises: a storage unit configured to store the configuration information about the image processing apparatus; and a changing unit configured to change the identification information and/or the function information included in the configuration information stored by the storage unit depending on reporting contents from the reporting unit.

In a second aspect of the present invention, there is provided an image processing apparatus comprising: a receiving unit configured to receive configuration information including identification information which identifies an apparatus and function information which represents functions of the apparatus; a comparison unit configured to compare the configuration information received by the receiving unit with configuration information about the image processing apparatus; and a reporting unit configured to, as a result of the comparison made by the comparison unit, report to the another image processing apparatus that there is a difference in the identification information if there is a difference in the identification information but there is no difference in the function information, report to the another image processing apparatus that there is a difference in the function information if there is no difference in the identification information but there is a difference in the function information, and report to the another image processing apparatus that there are differences both in the identification information and in the function information, respectively, if there are differences both in the identification information and in the function information, respectively.

In a third aspect of the present invention, there is provided an image processing apparatus comprising: a storage unit configured to store function information about another image processing apparatus; a receiving unit configured to receive function information about an apparatus; a comparison unit configured to compare the function information received by the receiving unit with function information stored by the storage unit; a changing unit configured to change the function information stored by the storage unit to the function information represented by the receiving unit if function represented by the function information stored by the storage unit are included in functions represented by the function information received by the receiving unit; and an inquiry unit configured to inquire whether or not a user wants to change the function information by the storage unit to the function information received by the receiving unit if the functions represented by the function information stored by the storage unit are not included in the functions represented by the function information received by the receiving unit.

In a fourth aspect of the present invention, there is provided a control method for an image processing apparatus which communicates with another image processing apparatus, comprising: a receiving step of receiving configuration information including identification information which identifies an apparatus and function information which represents functions of the apparatus; a comparison step of comparing the configuration information received by the receiving unit with configuration information about the image processing apparatus; and a reporting step of, as a result of the comparison made by the comparison unit, reporting to the another image processing apparatus that there is a difference in the identification information if there is a difference in the identification information but there is no difference in the function information, reporting to the another image processing apparatus that there is a difference in the function information if there is no difference in the identification information but there is a difference in the function information, and reporting to the another image processing apparatus that there are differences both in the identification information and in the function information, respectively, if there are differences both in the identification information and in the function information, respectively.

In a fifth aspect of the present invention, there is provided a control method for an image processing apparatus, comprising: a storage step of storing function information about another image processing apparatus; a receiving step of receiving function information about an apparatus; a comparison step of comparing the function information received by the receiving unit with function information stored by the storage unit; a changing step of changing the function information stored by the storage unit to the function information represented by the receiving unit if function represented by the function information stored by the storage unit are included in functions represented by the function information received by the receiving unit; and an inquiry step of inquiring whether or not a user wants to change the function information by the storage unit to the function information received by the receiving unit if the functions represented by the function information stored by the storage unit are not included in the functions represented by the function information received by the receiving unit.

In a sixth aspect of the present invention, there is provided a program that causes a computer to implement a control method for an image processing apparatus which communicates with another image processing apparatus, the control method comprising: a receiving step of receiving configuration information including identification information which identifies an apparatus and function information which represents functions of the apparatus; a comparison step of comparing the configuration information received by the receiving unit with configuration information about the image processing apparatus; and a reporting step of, as a result of the comparison made by the comparison unit, reporting to the another image processing apparatus that there is a difference in the identification information if there is a difference in the identification information but there is no difference in the function information, reporting to the another image processing apparatus that there is a difference in the function information if there is no difference in the identification information but there is a difference in the function information, and reporting to the another image processing apparatus that there are differences both in the identification information and in the function information, respectively, if there are differences both in the identification information and in the function information, respectively.

In a seventh aspect of the present invention, there is provided a program that causes a program to implement a control method for an image processing apparatus, the control method comprising: a storage step of storing function information about another image processing apparatus; a receiving step of receiving function information about an apparatus; a comparison step of comparing the function information received by the receiving unit with function information stored by the storage unit; a changing step of changing the function information stored by the storage unit to the function information represented by the receiving unit if function represented by the function information stored by the storage unit are included in functions represented by the function information received by the receiving unit; and an inquiry step of inquiring whether or not a user wants to change the function information by the storage unit to the function information received by the receiving unit if the functions represented by the function information stored by the storage unit are not included in the functions represented by the function information received by the receiving unit.

According to the present invention, it is possible to easily change settings on a linking image processing apparatus when a linked image processing apparatus is replaced to result in changes in setting information such as an IP address and functions of the image processing apparatus.

The above and other objects, features, and advantages of the invention will become more apparent from the following detailed description taken in conjunction with the accompanying drawings.

### BRIEF DESCRIPTION OF THE DRAWINGS

FIG. 1 is a view schematically showing a configuration of an image processing system according to an embodiment of the present invention.

FIG. 2 is a block diagram schematically showing an internal configuration of an image processing apparatus in FIG. 1.

FIG. 3 is a view showing an example of apparatus information managed by the apparatus information processing unit in FIG. 2.

FIG. 4 is a view showing an example of apparatus information about a linked image processing apparatus managed by the remote apparatus management unit shown in FIG. 2.

FIG. 5 is a view showing an example of link function information managed by the remote apparatus management unit in FIG. 2.

FIG. 6 is a view outlining a process which takes place upon replacement of a linked image processing apparatus.

FIG. 7 is a flowchart showing the procedures of a change information reporting process performed by the replaced new image processing apparatus.

FIG. 8 is a view showing an example of change information reported to the linking MFP0001 in step S104 in FIG. 7.

FIG. 9 is a flowchart showing the procedures of an information changing process performed by the linking MFP0001 upon receiving the change information.

FIG. 10 is a flowchart showing the procedures of an advising process performed by the linking MFP0001 when a user uses the linking MFP0001 on which an advice flag is set to ON.

FIG. 11 is a view showing an example of a screen displayed on the user interface apparatus in step S402 in FIG. 10.

FIG. 12 is a view showing an example of a screen displayed on the user interface apparatus in step S406 in FIG. 10.

FIG. 13 is a view showing an example of a screen displayed on the user interface apparatus in step S407 in FIG. 10.

### DETAILED DESCRIPTION OF THE PREFERRED EMBODIMENTS

The present invention will now be described in detail with reference to the drawings showing preferred embodiments thereof.

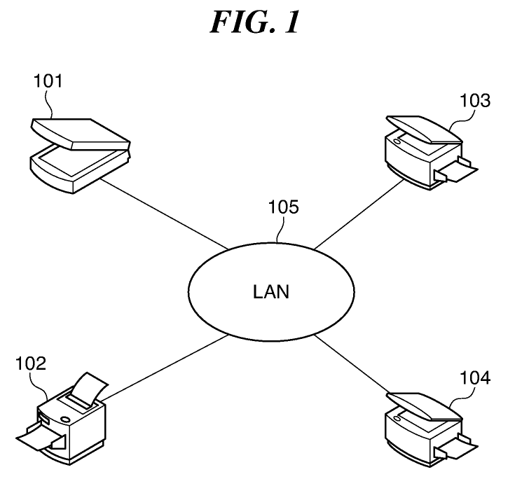

FIG. 1 is a view schematically showing a configuration of an image processing system according to an embodiment of the present invention.

As shown in FIG. 1, the image processing system according to the embodiment of the present invention includes an input apparatus 101 such as a scanner which has an image scanning function, an output apparatus 102 such as a printer which has an image printing function, and image processing apparatuses 103 and 104 comprising multiple function peripheries. The image processing apparatus 103 and 104, which are so-called multifunction apparatus, have image scanning, printing, facsimileing, and e-mail communicating functions.

The apparatuses 101, 102, 103, and 104 connected to one another via a network 105 (communication circuit) such as a LAN, allowing data to be exchanged with one another. For example, data scanned by the input apparatus 101 can be facsimiled by the image processing apparatus 104 or data received via fax by the image processing apparatus 104 can be printed out by the output apparatus 102. Moreover, the network 105 may be a typical public circuit or the like other than a LAN.

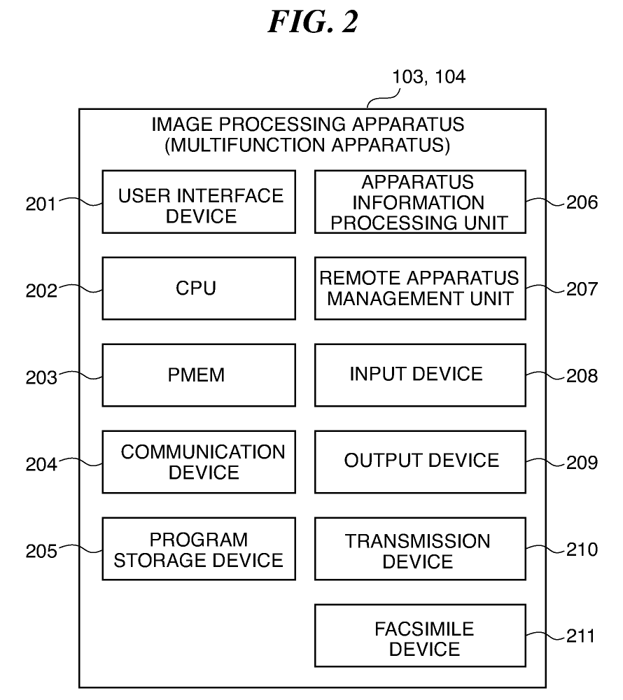

Next, a description will be given of an internal configuration of the image processing apparatus 103 and 104 with reference to FIG. 2.

FIG. 2 is a block diagram schematically showing an internal configuration of the image processing apparatus 103, 104 in FIG. 1. It is assumed for convenience of illustration that the image processing apparatuses 103 and 104 as multifunction apparatuses are identical in functionality, but of course, image processing apparatuses may differ in functionality from one another.

As shown in FIG. 2, each of the image processing apparatuses 103 and 104 includes a user interface device 201, CPU 202, a PMEM (program memory) 203, a communication device 204, a program storage device 205, and an apparatus information processing unit 206. Besides, each of the image processing apparatuses 103 and 104 has a remote apparatus management unit 207, an input device 208, an output device 209, a transmission device 210, and a facsimile device 211.

The user interface device 201 processes user operations, information display, and the like. The program memory 203 selectively reads an image processing program from the program storage device 205 which includes a hard disk, ROM, and the like. The program read into the program memory 203 is executed by the CPU 202.

The PMEM 203 stores data inputted from the user interface device 201 and image data read by the input device 208. The communication device 204 controls connection to the network 105 and data input/output via the network 105.

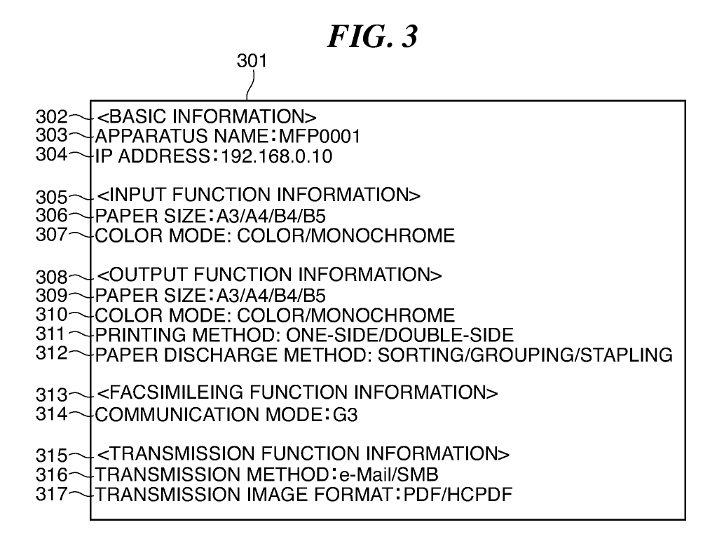

The apparatus information processing unit 206 holds and provides apparatus information about the image processing apparatuses 103 and 104, manages apparatus information about the linked image processing apparatus, and so on (FIG. 3). The remote apparatus management unit 207 manages the apparatus information and link function information about the linked image processing apparatus on the network 105.

The input device 208 reads images and the output device 209 outputs image data. The transmission device 210 transmits the inputted image data via e-mail or as a file. The facsimile device 211 performs transmission and reception of facsimile. According to the present embodiment, the image processing apparatuses 103 and 104 are supposed to be multifunction apparatuses each equipped with all of the input device 208, the output device 209, the transmission device 210, and the facsimile device 211. However, the image processing apparatus according to the embodiment of the present invention does not have to include all these devices, and only needs to include at least one of the devices.

FIG. 3 is a view showing an example of apparatus information managed by the apparatus information processing unit 206 shown in FIG. 2.

As shown in FIG. 3, apparatus information 301 mainly includes basic information 302, input function information 305, output function information 308, facsimileing function information 313, and transmission function information 315 about the apparatus. According to the present embodiment, the input function information 305, the output function information 308, the facsimileing function information 313, and the transmission function information 315 are collectively referred to as “the function information”.

The basic information 302 includes Apparatus Name 303 as well as IP Address 304 for the apparatus to connect to the network 105.

The input function information 305 includes readable Paper Size 306 and readable Color Mode 307.

The output function information 308 includes printable Paper Size 309; printable Color Mode 310; Printing Method 311 such as One-side Printing, Double-side Printing, or Bindery Printing; and Paper Discharge Method 312 such as Sorting, Grouping, or Stapling.

The Facsimileing Function Information 313 includes Communication Mode 314.

The transmission function information 315 includes Transmission Method 316 such as e-Mail or SMB and Transmission Image Format 317 such as PDF or HC (high compression) PDF.

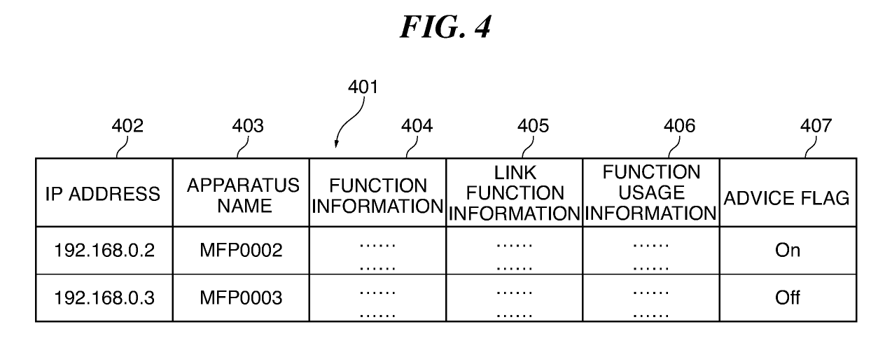

FIG. 4 is a view showing an example of apparatus information about a linked image processing apparatus managed by the remote apparatus management unit 207 shown in FIG. 2.

As shown in FIG. 4, apparatus information 401 is classified into an IP address area 402, an apparatus name area 403, a function information area 404, a link function information area 405, a function usage information area 406, and an advice flag area 407.

The IP address area 402 contains the IP addresses of the linked image processing apparatuses. According to the present embodiment, the image processing apparatuses are managed based on the IP addresses, but other identification information may be used as long as the identification information allows identification of the image processing apparatus on the network.

The apparatus name area 403 contains the apparatus names of the linked image processing apparatuses. In FIG. 4, “MFP0002” and “MFP0003” are set as the names of the linked image processing apparatuses.

The function information area 404 holds apparatus information acquired from the apparatus information processing unit 206 of the linked image processing apparatus. Specifically, the information held here includes items of function information corresponding to the input function, the output function, the facsimileing function, and the transmission function out of information in the data format shown in FIG. 3.

The link function information area 405 contains information about a link function implemented by a link with the linked image processing apparatus.

The function usage information area 406 contains information about functions actually used through a link out of the functions of the linked image processing apparatus. For example, if a color print output function is used through a link, the function usage information area 406 contains information about the color print output function.

The advice flag area 407 contains an advice flag. The advice flag, which will be described later, is normally set to OFF.

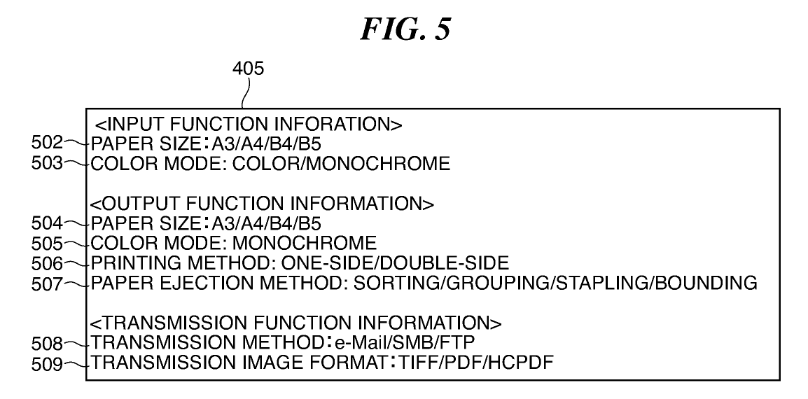

FIG. 5 shows an example of link function information 405 managed by the remote apparatus management unit 207 in FIG. 2. In FIG. 5, the link function information 405 concerns a link between the linking image processing apparatus 103 designated by MFP0001 and the linked image processing apparatus 104 designated by MFP0002 and registered in MFP0001. The link function information 405 includes information about functions implemented by the use of the output function, the facsimileing function, the transmission function, and the like of the linked MFP0002.

Input function information 502, 503 is the same as the input function information in FIG. 3 because the input functions of the image processing apparatus in FIG. 3 are used. Specifically, the input function information 502, 503 includes readable Paper Size 306 and readable Color Mode 307.

Output function information 504, 505, 506, and 507 includes information about the output functions of the linked MFP0002 because the output functions of the linked MFP0002 are used.

Transmission function information 508, 509 includes information about the transmission apparatus of the linked MFP0002 because the transmission apparatus of the linked MFP0002 is used.

Next, assuming that the MFP0002 as the image processing apparatus 104 is registered as a link target of the MFP0001 as the linking image processing apparatus 103, a description will be given of a process which will take place if the linked MFP0002 is replaced.

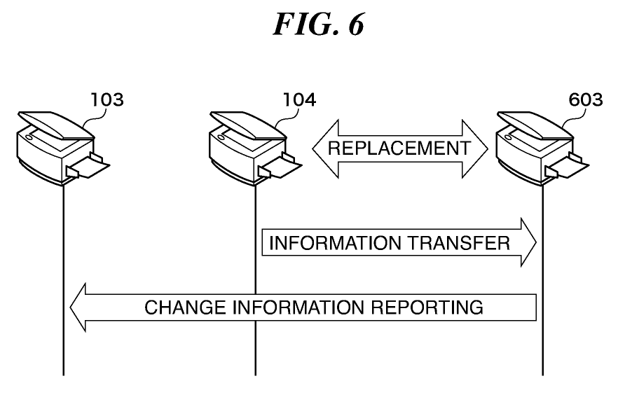

FIG. 6 is a view outlining a process which takes place upon replacement of a linked image processing apparatus.

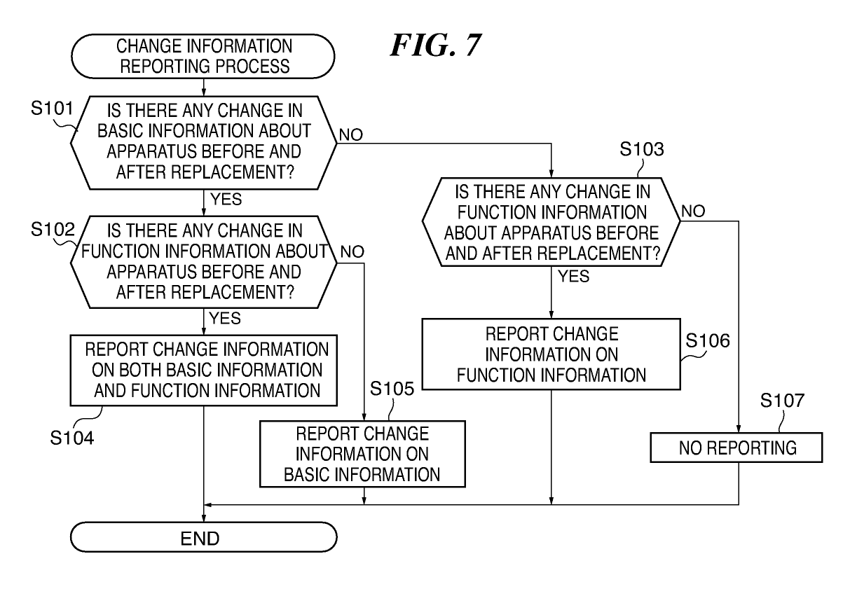

According to the present embodiment, the MFP0002 as the not-yet-replaced image processing apparatus 104 is replaced with the MFP0010 as the replaced image processing apparatus 603. At the time of replacement, the MFP0002 transfers its configuration information to the MFP0010 through a process of FIG. 7 described later. Regarding a transferring method, any method may be used including transfer via a network and transfer via a removable storage such as a USB memory.

Alternatively, the user may input the configuration information about the MFP0002 manually in the MFP0010.

The configuration information to be transferred from the MFP0002 to the MFP0010 is the apparatus information, the apparatus information about the linked image processing apparatus, and link function information held in the MFP0002, which are described with reference to FIGS. 3, 4, and 5. Upon receiving the configuration information, the MFP0010 analyzes the configuration information and reports change information to the linking MFP0001 on the network 105 if necessary. Upon receiving the change information, the MFP0001 performs necessary processes.

FIG. 7 is a flowchart showing the procedures of a change information reporting process performed by the replaced image processing apparatus.

Referring to FIG. 7, in step S101, the MFP0010 determines whether or not there is any change in the basic information (FIG. 3) included in the apparatus information before and after the replacement of the image processing apparatus, i.e., between the not-yet-replaced MFP0002 and the replaced MFP0010. In steps S102 and S103, the MFP0010 compares the function information (FIG. 3) in the apparatus information between the MFP0002 and the MFP0010 to check whether or not there is any change.

If it is found as a result of the determination in step S101 that there is any change in the basic information and it is found as a result of the determination in step S102 that there is any change in the function information, the MFP0010 reports change information on both the basic information and function information to the MFP0001 (step S104), followed by terminating the process.

If it is found as a result of the determination in step S101 that there is any change in the basic information, but if it is found as a result of the determination in step S102 that there is no change in the function information, the MFP0010 reports change information on the basic information to the MFP0001 (step S105), followed by terminating the process.

On the other hand, if it is found as a result of the determination in step S101 that there is no change in the basic information and it is found as a result of the determination in step S103 that there is any change in the function information, the MFP0010 reports change information on the function information to the MFP0001 (step S106), followed by terminating the process.

If it is found as a result of the determination in step S101 that there is no change in the basic information and it is found as a result of the determination in step S103 that there is no change in the function information, there is no reporting to the MFP0001 (step S107), followed by terminating the process. When the process goes through step S107, the linking MFP0001 (image processing apparatus 103) can use the linked image processing apparatus without changing the configuration information even if the linked MFP0002 (image processing apparatus 104) has been replaced with the MFP0010 (image processing apparatus 603).

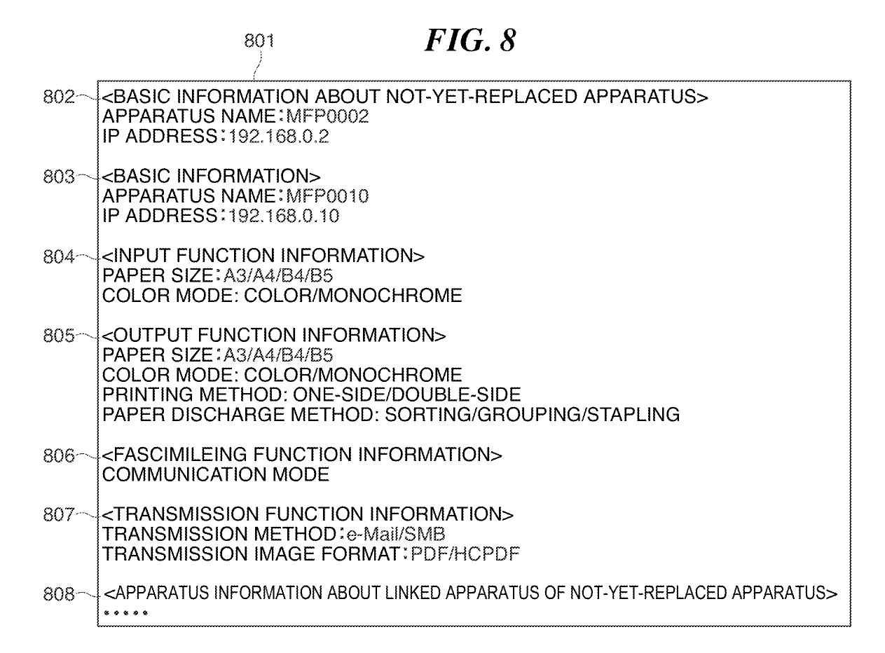

FIG. 8 is a view showing an example of change information reported to the linking MFP0001 in step S104 in FIG. 7.

The change information 801 includes basic information 802 about the MFP0002 which is the not-yet-replaced image processing apparatus as well as basic information 803 and function information 804, 805, 806, and 807 about the MFP0010 which is the replaced image processing apparatus 603. Data items of the function information 804, 805, 806, and 807 are the same as those shown in FIG. 3. The change information 801 includes apparatus information 808 about the MFP0002 linked to the not-yet-replaced MFP0001. Data items of the apparatus information 808 are the same as those shown in FIG. 4.

Moreover, the change information reported to the MFP0001 in step S105 in FIG. 7 includes only the basic information 802 about the not-yet-replaced MFP0002 and basic information 803 about the replaced MFP0010.

On the other hand, the change information reported to the MFP0001 in step S106 in FIG. 7 includes only the basic information 802 and apparatus information 808 about the not-yet-replaced MFP0002 and the function information 804, 805, 806, and 807 about the replaced MFP0010.

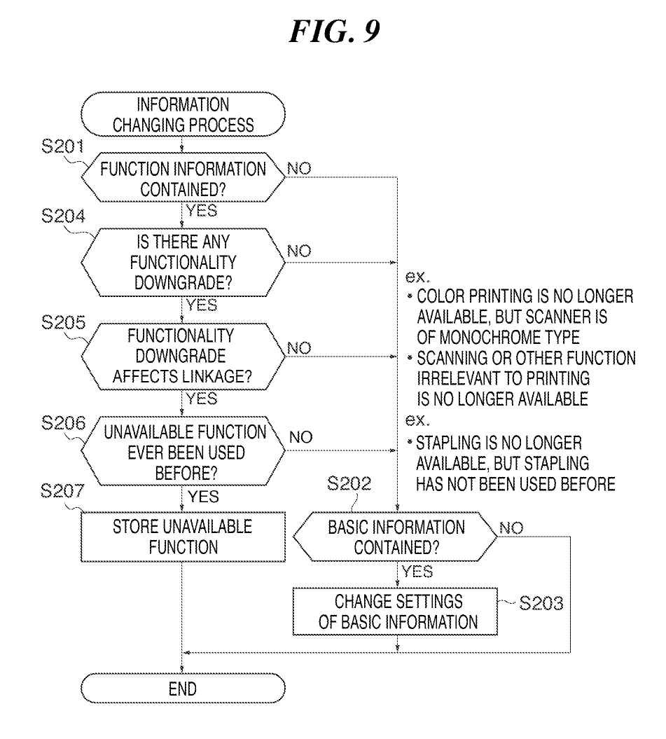

FIG. 9 is a flowchart showing the procedures of an information changing process performed by the linking MFP0001 upon receiving the change information 801.

Upon receiving the change information, the MFP0001 determines whether or not the MFP0002 is registered as a link target, based on the basic information 802 about the not-yet-replaced MFP0002. If it is determined that the MFP0002 is registered, the MFP0001 carries out the processes in step S201 and subsequent steps.

In step S201, the MFP0001 determines whether or not the received change information contains the function information 804, 805, 806, and 807 about the replaced MFP0010.

If it is found as a result of the determination in step S201 that the change information does not contain the function information 804, 805, 806, and 807 about the MFP0010, the MFP0010 can be used by changing only the basic information; therefore the process goes directly to step S202, where it is determined whether or not the received change information contains the basic information 803 about the replaced MFP0010. If it is found as a result of the determination in step S202 that the received change information contains the basic information 803 about the MFP0010, the MFP0001 changes the basic information among the apparatus information (FIG. 4) about the linked image processing apparatus managed by the remote apparatus management unit 207 by substituting the IP address area 402 and apparatus name area 403 with corresponding items of the basic information 803 about the MFP0010 (step S203), followed by terminating the process.

If it is found as a result of the determination in step S201 that the change information contains the function information 804, 805, 806, and 807 about MFP0010, the process goes to step S204, where it is determined whether or not there is any functionality downgrade compared to the not-yet-replaced MFP0002. If there is no functionality downgrade, the MFP0010 can be used as it is; therefore the process goes to steps S202 and S203 as is the case with the mentioned above, followed by terminating the process.

If any functionality downgrade is found in step S204, the process goes to step S205, where it is determined whether or not the functionality downgrade affects the linkage. Suppose a color print output function is no longer available, if the input function does not support color scanning, the unavailable function does not undergo an influence; thereby enabling the MFP0010 to be used as it is. Thus, if the functionality downgrade does not affect the linkage (NO to the step S205), there are carried out the processes of steps S202 and S203 as is the case with the mentioned above, followed by terminating the process.

If it is found as a result of the determination in step S205 that the functionality downgrade affects the link, the process goes to step S206, where it is determined whether or not the unavailable function has never been used before.

Specifically, the MFP0001 acquires the function usage information 406 in FIG. 4 and then it is determined whether or not the unavailable function is contained in the function usage information 406. If the unavailable function has never been used before, the MFP0010 can be used as it is; therefore there are carried out the processes of S202 and S203 as is the case with the mentioned above, followed by terminating the process.

If it is found as a result of the determination in step S206 that the unavailable function has been used before, the process goes to step S207, where the advice flag in the advice flag area 407 in FIG. 4 is set to ON and information about the unavailable function is stored, followed by terminating the process. The advice flag ON means that the linked apparatus has been replaced and that the replaced new apparatus cannot be used as before. Information about the unavailable function stored in step S207 is used for an advising process performed by the linking MFP0001 when the user operates the MFP0001 on which the advice flag is set to ON.

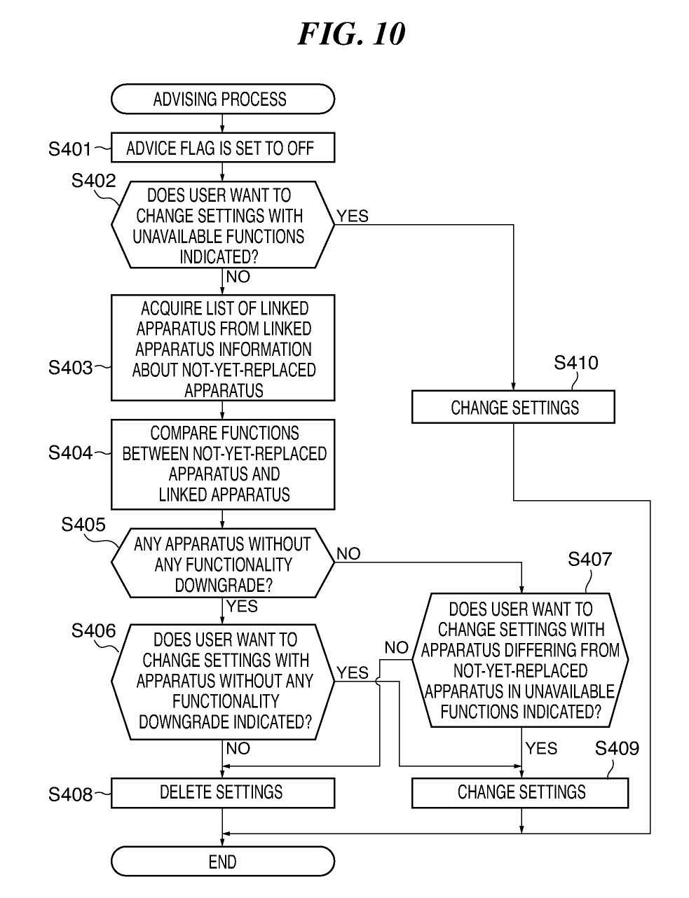

FIG. 10 is a flowchart showing the procedures of the advising process performed by the linking MFP0001 when the user uses the linking MFP0001 on which the advice flag is set to ON.

Referring to FIG. 10, the advice flag is set to OFF (step S401), and then the functions which have become unavailable as a result of the replacement of the linked apparatus (details of the functionality downgrade) are displayed on the user interface apparatus 201 (FIG. 11), and it is asked to the user whether or not the user wants to change settings (step S402). If the user agrees to predetermined setting changes via the user interface apparatus 201 or the like, the apparatus information in the remote apparatus management unit is changed based on the configuration information about the linked apparatus (MFP0010) (step S410), followed by terminating the process.

If it is found as a result of the determination in step S402 that the user does not agree to the setting changes, the process goes to step S403, where a list of an apparatus linked to the MFP0002 from the apparatus information 808 about the not-yet-replaced MFP0002. This is because these linked apparatuses are used by the not-yet-replaced MFP0002 and are likely to be located near the MFP0002.

Next, the function information about the linked apparatus acquired in step S403 is compared with the function information about the not-yet-replaced MFP0002 (step S404), followed by the process proceeding to step S405.

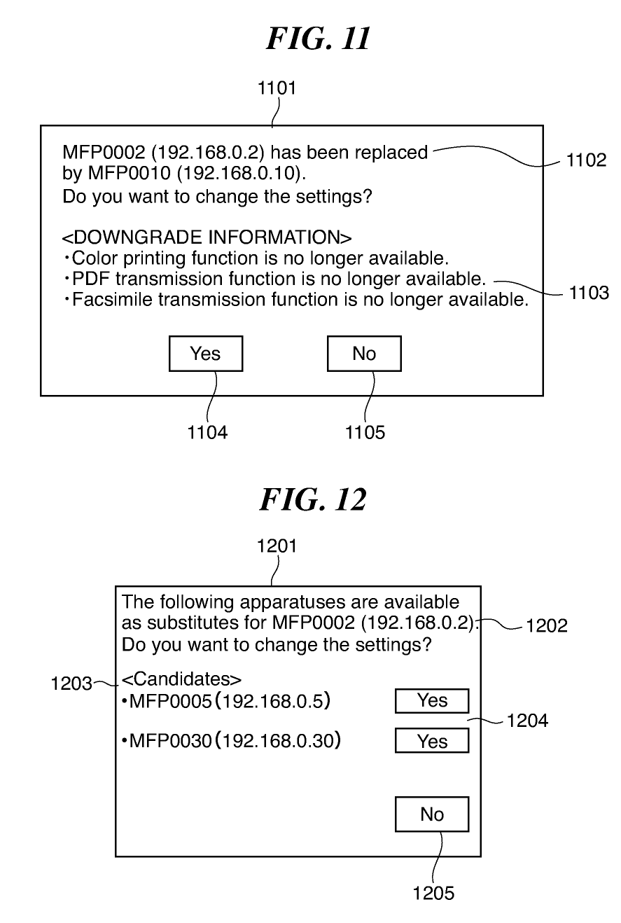

In step S405, it is determined, based on comparison results produced in step S404, whether or not there is any apparatus without any functionality downgrade from the MFP0002 among the linked apparatuses. If there is any apparatus without any functionality downgrade among the linked apparatuses, the process goes to step S406, where the apparatus without any functionality downgrade is displayed via the user interface apparatus 201 and it is asked to the user whether or not the user wants to change settings (FIG. 12). If the user indicates via the user interface apparatus 201 or the like that the user does not agree to the setting changes, there is no apparatus to be proposed; therefore the settings of the linked apparatus are deleted (step S408), followed by terminating the process. If it is found as a result of the determination in step S406 that the user agrees to the setting changes, the apparatus information in the remote apparatus management unit is changed based on the configuration information about the linked apparatus selected by the user via the user interface apparatus 201 (step S409), followed by terminating the process.

If it is found as a result of the determination in step S405 that there is no apparatus without any functionality downgrade among the linked apparatuses, the process goes to step S407.

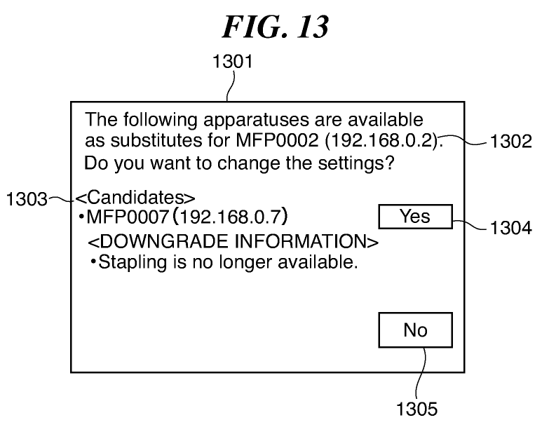

In step S407, the functions unavailable on the linked apparatus acquired in step S403 are compared with the functions unavailable on the not-yet-replaced MFP0002, and then an apparatus which differs from the MFP0002 in unavailable functions is selected and it is asked to the user whether or not the user wants to change settings via the user interface apparatus 201 (FIG. 13). If the user does not agree to the setting changes, there is no apparatus to be proposed; therefore the settings of the linked apparatus are deleted (step S408), followed by terminating the process. On the other hand, if the user agrees to the setting changes, the apparatus information in the remote apparatus management unit is changed based on configuration information about the linked apparatus selected by the user via the user interface apparatus 201 (step S409), followed by terminating the process.

FIG. 11 is a view showing an example of a screen displayed on the user interface apparatus 201 in step S402 in FIG. 10.

Referring to FIG. 11, a screen 1101 of the user interface apparatus 201 presents the basic information about the MFP0002 as the not-yet-replaced apparatus and basic information about the MFP0010 as the replaced apparatus and displays a message 1102 asking the user whether or not the user wants to change settings. Also, the screen 1101 displays a list 1103 of functions no longer available with the MFP0010 as the replaced apparatus. Furthermore, the screen 1101 displays buttons 1104 and 1105 for the user to indicate whether or not the user agrees to the setting changes.

FIG. 12 is a view showing an example of a screen displayed on the user interface apparatus 201 in step S406 in FIG. 10.

A screen 1201 presents the basic information about the MFP0002 as the not-yet-replaced apparatus and displays a message 1202 asking the user whether or not the user wants to change settings to those of a substitute candidate. Also, the screen 1201 displays a candidate apparatus list 1203. Furthermore, the screen 1201 displays buttons 1204 and 1205 for the user to select or deselect which apparatus from the candidate apparatus list 1203.

FIG. 13 is a view showing an example of a screen displayed on the user interface apparatus 201 in step S407 in FIG. 10.

Referring to FIG. 13, a screen 1301 of the user interface apparatus 201 presents the basic information about the MFP0002 as the not-yet-replaced apparatus and displays a message 1302 asking the user whether the user wants to change settings to those of a substitute candidate. Also, the screen 1301 displays a candidate apparatus list 1303 together with basic information about the candidate apparatus and unavailable information. Furthermore, the screen 1301 displays buttons 1304 and 1305 for the user to select or deselect which apparatus from the candidate apparatus list 1303.

As described above, the present embodiment makes it possible to easily change settings on the linking image processing apparatus 101 when the linked image processing apparatus 104 is replaced by the image processing apparatus 603, resulting in changes in an IP address, functions, and other configuration information.

Also, as shown in FIGS. 11 to 13, the user can decide whether to change the apparatus information about a linked image processing apparatus registered in an image processing apparatus which has received change information, depending on the functionality of the linked image processing apparatus.

It is to be understood that the present invention is not limited to the embodiment described above, and various changes may be made without departing from the spirit of the invention.

Also, it is to be understood that the object of the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium.

In this case, the program code itself read from the storage medium realizes the functions of the embodiment described above, and hence the program code and the storage medium in which the program code is stored constitute the present invention.

Examples of the storage medium for supplying the program code include a floppy (registered trademark) disk, a hard disk, a magnetic-optical disk, a CD-ROM, a CD-R, a CD-RW, a DVD-ROM, a DVD-RAM, a DVD-RW, DVD+RW, a magnetic tape, a nonvolatile memory card, and a ROM. Alternatively, the program code may be downloaded via a network.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2007-120982 filed May 1, 2007, which is hereby incorporated by reference herein in its entirety.

1. An image processing system comprising an image processing apparatus, and another image processing apparatus which performs a processing through linkage with said image processing apparatus,
wherein said image processing apparatus comprises:
a receiving unit configured to receive configuration information including identification information which identifies an apparatus and function information which represents functions of the apparatus;
a comparison unit configured to compare the configuration information received by said receiving unit with configuration information about said image processing apparatus; and
a reporting unit configured to, as a result of the comparison made by said comparison unit, report to said another image processing apparatus that there is a difference in the identification information if there is a difference in the identification information but there is no difference in the function information, report to said another image processing apparatus that there is a difference in the function information if there is no difference in the identification information but there is a difference in the function information, and report to said another image processing apparatus that there are differences both in the identification information and in the function information, respectively, if there are differences both in the identification information and in the function information, respectively, and
wherein said another image processing apparatus comprises:
a storage unit configured to store the configuration information about said apparatus; and
a changing unit configured to change the identification information and/or the function information included in the configuration information stored by said storage unit depending on reporting contents from said reporting unit.

2. An image processing apparatus comprising:
a receiving unit configured to receive configuration information including identification information which identifies an apparatus and function information which represents functions of the apparatus;
a comparison unit configured to compare the configuration information received by said receiving unit with configuration information about said image processing apparatus; and
a reporting unit configured to, as a result of the comparison made by said comparison unit, report to the another processing apparatus that there is a difference in the identification information if there is a difference in the identification information but there is no difference in the function information, report to the another processing apparatus that there is a difference in the function information if there is no difference in the identification information but there is a difference in the function information, and report to the another processing apparatus that there are differences both in the identification information and in the function information, respectively, if there are differences both in the identification information and in the function information, respectively.

3. An image processing apparatus comprising:
a storage unit configured to store function information about another image processing apparatus;
a receiving unit configured to receive function information about an apparatus;
a comparison unit configured to compare the function information received by said receiving unit with function information stored by said storage unit;
a changing unit configured to change the function information stored by said storage unit to the function information received by the receiving unit if function represented by the function information stored by said storage unit are included in functions represented by the function information received by said receiving unit; and
an inquiry unit configured to inquire whether or not a user wants to change the function information by said storage unit to the function information received by said receiving unit if the functions represented by the function information stored by said storage unit are not included in the functions represented by the function information received by said receiving unit.

4. An image processing apparatus as claimed in claim 3, wherein:
said storage unit stores identification information about the another image processing apparatus,
said receiving unit receives identification information about the apparatus; and
said changing unit changes, when said receiving unit receives the identification information about the apparatus, the identification information stored by said storage unit to the identification information received by said receiving unit regardless of whether or not the functions represented by the function information stored by said storage unit are included in the functions represented by the function information received by said receiving unit.

5. An image processing apparatus as claimed in claim 3, wherein said inquiry unit reports to the user functions not included in the functions represented by the function information received by said receiving unit among the functions represented by the function information stored by said storage unit.

6. An image processing apparatus as claimed in claim 3, further comprising a determination unit configured to determine whether or not functions not included in the functions represented by the function information received by said receiving unit among the functions represented by the function information stored by said storage unit are relevant to a linkage processing, wherein:
said changing unit changes the function information stored by said storage unit to the function information received by said receiving unit, when said determination unit makes a negative determination, and
said inquiry unit inquires to the user whether or not the user wants to change the function information stored by said storage unit to the function information received by said receiving unit, when said determination unit makes an affirmative determination.

7. An image processing apparatus as claimed in claim 3, further comprising a determination unit configured to determine whether or not functions not included in the functions represented by the function information received by said receiving unit among the functions represented by the function information stored by said storage unit have ever been used in a linkage processing, wherein:
said changing unit changes the function information stored by said storage unit to the function information received by said receiving unit, when said determination unit makes a negative determination, and
said inquiry unit inquires to the user whether or not the user wants to change the function information stored by said storage unit to the function information received by said receiving unit, when said determination unit makes an affirmative determination.

8. A control method for an image processing apparatus which communicates with another image processing apparatus, the method comprising:
a receiving step of receiving configuration information including identification information which identifies an apparatus and function information which represents functions of the apparatus;
a comparison step of comparing the configuration information received at said receiving step with configuration information about said image processing apparatus; and
a reporting step of, as a result of the comparison made at said comparison step, reporting to said another processing apparatus that there is a difference in the identification information if there is a difference in the identification information but there is no difference in the function information, reporting to said another processing apparatus that there is a difference in the function information if there is no difference in the identification information but there is a difference in the function information, and reporting to said another processing apparatus that there are differences both in the identification information and in the function information, respectively, if there are differences both in the identification information and in the function information, respectively.

9. A control method for an image processing apparatus, comprising:
a storage step of storing function information about another image processing apparatus;
a receiving step of receiving function information about an apparatus;
a comparison step of comparing the function information received at said receiving step with function information stored at said storage step;
a changing step of changing the function information stored at said storage step to the function information represented at the receiving step if function represented by the function information stored at said storage step are included in functions represented by the function information received at said receiving step; and
an inquiry step of inquiring whether or not a user wants to change the function information at said storage step to the function information received at said receiving step if the functions represented by the function information stored at said storage step are not included in the functions represented by the function information received at said receiving step.

10. A control method for an image processing apparatus, as claimed in claim 9, wherein:
said storage step comprises storing identification information about the another image processing apparatus,
said receiving step comprises receiving identification information about the apparatus, and
said changing step comprises changing, when the identification about the apparatus is received at said receiving step, the identification information stored at said storage step to the identification information received at said receiving unit regardless of whether or not the functions represented by the function information stored at said storage step are included in the functions represented by the function information received at said receiving step.

11. A control method for an image processing apparatus, as claimed in claim 9, wherein said inquiry step comprises reporting to the user functions not included in the functions represented by the function information received at said receiving step among the functions represented by the function information stored at said storage step.

12. A control method for an image processing apparatus, as claimed in claim 9, further comprising a determination step comprises determining whether functions not included in the functions represented by the function information received at said receiving step among the functions represented by the function information stored at said storage step are relevant to a linkage processing, wherein:
said changing step comprises changing the function information stored at said storage step to the function information received at said receiving step, when said determination step makes a negative determination, and
said inquiry step comprises inquiring to the user whether or not the user wants to change the function information stored at said storage step to the function information received at said receiving step, when said determination step makes an affirmative determination.

13. A control method for an image processing apparatus, as claimed in claim 9, further comprising a determination step of determining whether or not functions not included in the functions represented by the function information received at said receiving step among the functions represented by the function information stored at said storage step have ever been used in a linkage processing, wherein:
said changing step comprises changing the function information stored at said storage step to the function information received at said receiving step, when said determination step makes a negative determination, and
said inquiry step comprises inquiring to the user whether or not the user wants to change the function information stored at said storage step to the function information received at said receiving step, when said determination step makes an affirmative determination.

14. A computer-readable medium storing a computer program that causes a computer to implement a control method for an image processing apparatus which communicates with another image processing apparatus, the control method comprising:
a receiving step of receiving configuration information including identification information which identifies an apparatus and function information which represents functions of the apparatus;
a comparison step of comparing the configuration information received at said receiving step with configuration information about said image processing apparatus; and
a reporting step of, as a result of the comparison made at said comparison step, reporting to said another image processing apparatus that there is a difference in the identification information if there is a difference in the identification information but there is no difference in the function information, reporting to said another image processing apparatus that there is a difference in the function information if there is no difference in the identification information but there is a difference in the function information, and reporting to said another image processing apparatus that there are differences both in the identification information and in the function information, respectively, if there are differences both in the identification information and in the function information, respectively.

15. A computer-readable medium storing a computer program that causes a program to implement a control method for an image processing apparatus, the control method comprising:
a storage step of storing function information about another image processing apparatus;
a receiving step of receiving function information about an apparatus;
a comparison step of comparing the function information received at said receiving step with function information stored at said storage step;
a changing step of changing the function information stored at said storage step to the function information received at the receiving step if function represented by the function information stored at said storage step are included in functions represented by the function information received at said receiving step; and
an inquiry step of inquiring whether or not a user wants to change the function information at said storage step to the function information received at said receiving step if the functions represented by the function information stored at said storage step are not included in the functions represented by the function information received at said receiving step.
